(19) United States
(12) Patent Application Publication
(10) Pub. No.: US 2008/0317364 A1
(43) Pub. Date: Dec. 25, 2008

(54) Methods for determining neighboring locations for partitions of a video stream

(75) Inventors: Dayin Gou, San Jose, CA (US); Changjiang Wei, Beijing (CN)

Correspondence Address: Venture Pacific Law, PC, 5201 Great America Parkway, Suite 270, Santa Clara, CA, 95054, US

(73) Assignee: AUGUSTA TECHNOLOGY, INC., Santa Clara, CA (US)

(21) Appl. No.: 12/146,076

(22) Filed: Jun. 25, 2008

Related U.S. Application Data
(60) Provisional application No. 60/946,116, filed on Jun. 25, 2007.

(51) Int. Cl. G06K 9/36; H04N 7/12; H04B 1/66; H04N 11/02

(52) U.S. Cl. 382/233; 375/240.24; 375/240.25; 375/E07.15; 375/E07.078

(57) ABSTRACT

This invention describes methods for pre-computing neighboring locations for partitions in a video stream and for placing those pre-computed neighboring locations into a table for later retrieval and later use. The redundancy in the information of the pre-computed neighboring locations can be used to reduce the number entries in the table of neighboring locations, thus effectively reducing the amount of memory needed to store this table. Further, indexing schemes are used for non-MBAFF coded video streams and MBAFF coded video streams to further minimize memory usage.

### CROSS REFERENCE

This application claims priority from a provisional patent application entitled “Efficient Methods For Calculating Neighboring Locations With Efficient Memory Usage” filed on Jun. 25, 2007 and having an Application No. 60/946,116. Said application is incorporated herein by reference.

### FIELD OF INVENTION

This invention relates to methods for decoding a video stream, and, in particular, to methods for determining neighboring locations for partitions in the decoding of a video stream.

### BACKGROUND

Advances in video compression techniques have revolutionized the way video information is transmitted, received, stored and displayed. Applications that use video compression include broadcast television, video on demand systems, and other applications where digital video information can be transmitted. These applications and many more are made possible by video compression technology.

Generally, compression allows video content to be transferred and stored using much lower data rates while still providing desirable picture quality, e.g., providing relatively pristine video at low data rates or at rates that use less bandwidth. To this end, compression identifies and eliminates redundancies in a signal to produce a compressed bit stream and provides instructions for reconstructing the bit stream into a picture when the bits are decompressed.

Most video compression standards, including the H.264, divide each input field or picture into blocks of fixed size, such as into macroblocks or into macroblock (“MB”) pairs. For non-macroblock-based adaptive frame/field coded video streams, a MB of 16×16 pixels can be used, and for macroblock-based adaptive frame/field (“MBAFF”) coded video streams, a MB pair of either 16×32 pixels or 16×16 pixels can be used.

Neighboring information is used extensively in the H.264 standard to achieve data compression. FIG. 1 is an illustration of a picture that has been partitioned into macroblocks. Referring to FIG. 1, given a current macroblock 102, the neighboring locations, if available, can refer to the adjacent top MB 106, the adjacent top-left MB 110, the adjacent top-right MB 108, and the adjacent left MB 104. The picture can also be segmented into MB pairs or other partitions.

Examples of the usages of neighboring information can be found in numerous areas of the H.264 standard. In context adaptive variable length coding (“CAVLC”), neighboring information can be used to determine which CAVLC table to use for processing a picture. In context adaptive binary arithmetic coding (“CABAC”), neighboring information can be used to determine the context index. In deblocking a picture, neighboring information can be used to determine the filtering strength. In motion vector decoding, neighboring information can be used in motion vector prediction.

In some cases, neighboring locations may be needed for pixel level processing, such as for intra picture prediction and for deblocking. In a vast majority of cases, neighboring locations may be needed for non-pixel level processing. For non-pixel level processing, neighboring locations must be equal to or coarser than blocks of 4×4 pixels, where a block of 4×4 pixels is the smallest-sized partition in the H.264 standard. The coarsest granular level can be at the MB level. For non-pixel level processing, the neighboring information is mainly used to derive other parameters needed for processing a partition in the current MB, herein referred to as the current partition.

In the H.264 standard, a neighboring location for a current partition can be expressed by a MB in which the location will fall and by the spatial coordinates of the pixel relative to the top-left corner of that MB. In the case of non-pixel level granularity, this can be equivalent to determining the MB index and the 4×4 block number since parameters for processing will be at the 4×4 block granularity at finest granularity. A naïve way to do this is to calculate the neighboring location every time that information is needed, as is done in the H.264 reference software called JM.

However, since neighboring locations can be extensively used in processing a picture, calculating neighboring locations each time the neighboring locations are needed can be very time consuming. On the other hand, if all the possible neighboring locations are calculated and stored in a table for later retrieval and later use, then a large amount of memory space is required to store this table since each type of partition for MBAFF coded video streams or for non-MBAFF coded video streams must be placed as an entry on that table. Calculating all the neighboring locations for the partitions of a picture may be herein referred to as pre-computing or pre-compute. Since the memory space required for the pre-computed table is too large to put into fast memory, the neighboring information has to be put into slower memory, thus increasing the overhead to access the slower memory.

Therefore, it is desirable to find methods to reduce the number of entries in a table of pre-computed neighboring locations and for quickly retrieving the entries within that table of pre-computed neighboring locations.

### SUMMARY

An object of the methods of this invention is to provide methods for reducing the amount of memory needed for storing pre-computed neighboring locations.

An object of the methods of this invention is to provide methods for quickly retrieving entries in a table of pre-computed neighboring locations.

Briefly, this invention describes methods for pre-computing neighboring locations for partitions in a video stream and for placing those pre-computed neighboring locations into a table for later retrieval and later use. The redundancy in the information of the pre-computed neighboring locations can be used to reduce the number of entries in the table of neighboring locations, thus effectively reducing the amount of memory needed to store this table. Further, indexing schemes are used for non-MBAFF coded video streams and MBAFF coded video streams to further minimize memory usage.

An advantage of the methods of this invention is that the amount of memory needed for storing the table of pre-computed neighboring locations can be reduced.

Another advantage of the methods of this invention is that pre-computed neighboring locations can be quickly retrieved for use.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 is an illustration of a picture that has been partitioned into macroblocks.

FIG. 2 is an illustration of an indexing scheme for a picture of a non-MBAFF coded video stream.

FIG. 3 is an illustration of the neighboring locations table provided in Appendix C, which is used for determining the neighboring locations for partitions of a non-MBAFF coded video stream.

FIG. 4 is an illustration of an indexing scheme for a picture of a MBAFF coded video stream.

FIGS. 5a-5b are illustrations of tables used for determining the neighboring locations for partitions of a MBAFF coded video stream.

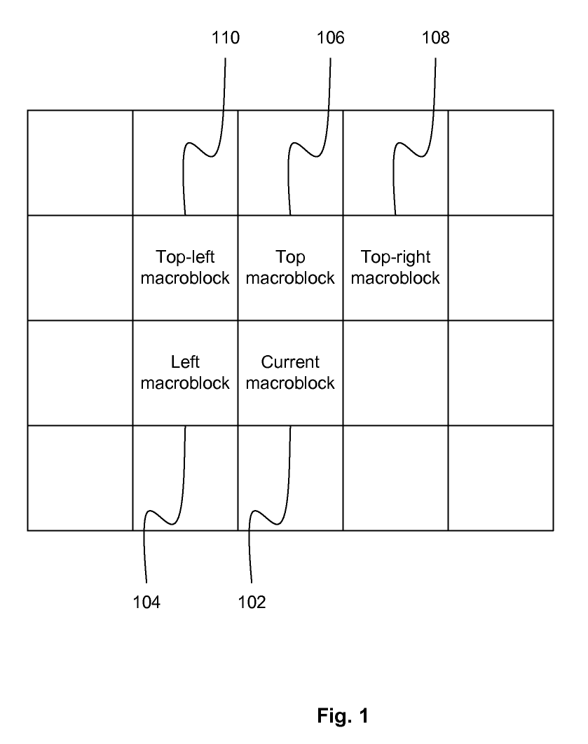

### DESCRIPTION OF THE PREFERRED EMBODIMENTS

### Neighboring Locations for Non-MBAFF Coded Video Streams

In non-MBAFF coded video streams, neighboring locations can be located at one of five MB addresses, unless some of those MBs are not available. Unavailable MBs can refer to MBs outside the boundary of the current picture or to MBs that have addresses greater than the current MB.

Assuming that a picture consists of a horizontal row of M macroblocks and the MB address of the current MB is m, then the following can be defined:
Index 0 can refer to the current MB with MB address m;
Index 1 can refer to the MB to the left of the current MB with MB address m−1;
Index 2 can refer to the MB to the top of the current MB with MB address m−M;
Index 3 can refer to the MB to the top-right with MB address m−M+1;
Index 4 can refer to the MB to the top-left with MB address m−M−1; and
Index 5 can refer to the unavailable MBs.

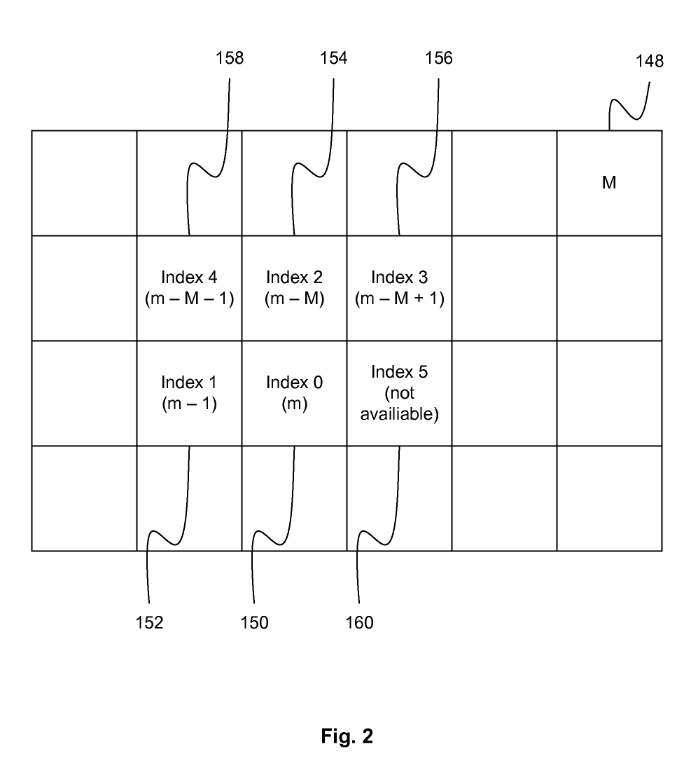

For instance, FIG. 2 is an illustration of the indexing scheme for a picture of a non-MBAFF coded video stream with rows that stretch M macroblocks. Referring to FIG. 2, given a current MB 150 and following the indexing scheme presented above for non-MBAFF coded video streams, MB 150 has Index 0, MB 152 has Index 1, MB 154 has Index 2, MB 156 has Index 3, MB 158 has Index 4, and other MBs that are unavailable, such as MB 160, have Index 5.

In H.264, the original partition/sub-partitions used for motion compensation units can be expressed with four parameters, where two parameters, x0 and y0, are the spatial coordinates of the top-left corner of the partition relative to the top-left corner of the MB, the parameter w represents the width of the partition, and the parameter h represents the height of the partition. The two parameters x0 and y0 can be herein written in the form of (x0, y0). There is a total of forty-one possible partitions for a typical MB of 16×16 pixels since there is one 16×16 partition, two 16×8 partitions, two 8×16 partitions, four 8×8 partitions, eight 8×4 partitions, eight 4×8 partitions, sixteen 4×4 partitions. Thus for each of the forty-one different types of possible partitions for a MB, the neighboring locations can be calculated and entered into a table.

However, in terms of using the neighboring locations for calculation at the non-pixel level, only the first three parameters, x0, y0, and w, are relevant for non-pixel calculations since the height of the original partition is not used in these calculations. For example, the neighboring locations for a 8×8 partition at coordinates (0, 0) will be the same for a 8×16 partition at coordinates (0, 0). With this property, the number of possible partitions can be reduced from forty-one entries, one for each original partition as shown in Appendix A, to twenty-six relevant partitions, as shown in Appendix B, where Appendix B may be herein referred to as relevant tables. The relevant partitions may also be referred to as “neighboring location relevant partitions.”

For each current location (where that current location may be a current partition), there exist four possible neighboring locations. For every neighboring location at non-pixel level granularity, MB index and block index can be used to represent the neighboring location, where the MB index can inclusively take the value of 0 to 5 for the non-MBAFF case, as defined in the indexing scheme above and illustrated in FIG. 2, and the block index is the 4×4 block number as defined in the H.264 standard. With this convention, the neighboring locations can be calculated for every partition and stored in a neighboring locations table. Each entry of the neighboring locations table can have the following eight fields listed in this order: (1) Mb A: MB index for the neighbor to the left of current MB; (2) Blk A: block index for the neighbor to the left of current MB; (3) Mb B: MB index for the neighbor to the top of current MB; (4) Blk B: block index for the neighbor to the top of current MB; (5) Mb C: MB index for the neighbor to the top-right of current MB; (6) Blk C: block index for the neighbor to the top-right of current MB; (7) Mb D: MB index for the neighbor to the top-left of current MB; (8) Blk D: block index for the neighbor to the top-left of current MB. The neighboring locations information for all the partitions can be summarized in a table shown in Appendix C, herein may be referred to as the “neighboring locations table.”

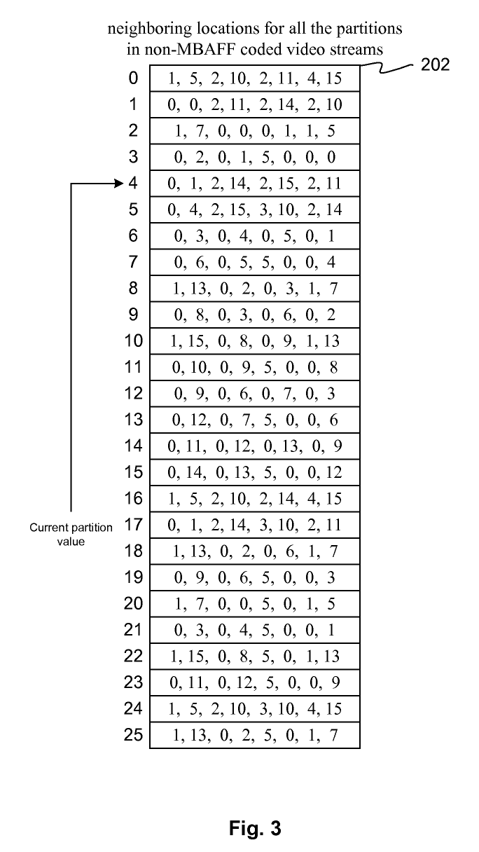

In the case of non-MBAFF coded video streams, a neighboring locations table, illustrated in Appendix C, may be used to find the neighboring locations for a current partition. The table can be directly accessed by using the value of the partition as the index. The value of a specified partition, herein referred to as the partition value, can be found using Appendix B. For instance, FIG. 3 is an illustration of a table used for looking up the neighboring locations for a picture of a non-MBAFF coded video stream. Referring to FIG. 3, the value of the current partition (“current partition value”) is used as the index for the table 202 to look up the corresponding neighboring locations for that current partition. The entries within the table 202 correspond to the neighboring locations for the 26 kinds of different partitions shown in Appendix B.

### Neighboring Locations for MBAFF Coded Video Streams

In MBAFF coded video streams, the neighboring location calculation is much more complex than for non-MBAFF coded video streams. Not only is the neighboring location calculation related to the current partition, but the calculation can also be related to other factors as well, such as whether the current MB pair is frame coded or field coded and whether the current MB is the top or bottom MB of the pair.

For MBAFF coded video streams, the neighboring location might fall into 1 of 11 MBs, unless some of those MBs are not available. Assuming that the picture contains a horizontal row of M macroblock pairs, where each MB pair consists of two vertically contiguous MBs, then there is a total of 2×M macroblocks in each row of M macroblock pairs.

Assuming the MB address of the current MB is m, the following can be defined for the eleven possible neighboring MBs:

Index 0 can refer to the MB at MB address m−2M−3;

Index 1 can refer to the MB at address m−2M−2;

Index 2 can refer to the MB at MB address m−2M−1;

Index 3 can refer to the MB at MB address m−2M;

Index 4 can refer to the MB at MB address m−2M+1;

Index 5 can refer to the MB at MB address m−2M+2;

Index 6 can refer to the MB at MB address m−2M+3;

Index 7 can refer to the MB at MB address m−1;

Index 8 can refer to the MB at MB address m−2;

Index 9 can refer to the MB at MB address m−3;

Index 10 can refer to the MB at MB address m, the current MB; and

Index 11 can refer to the unavailable MBs.

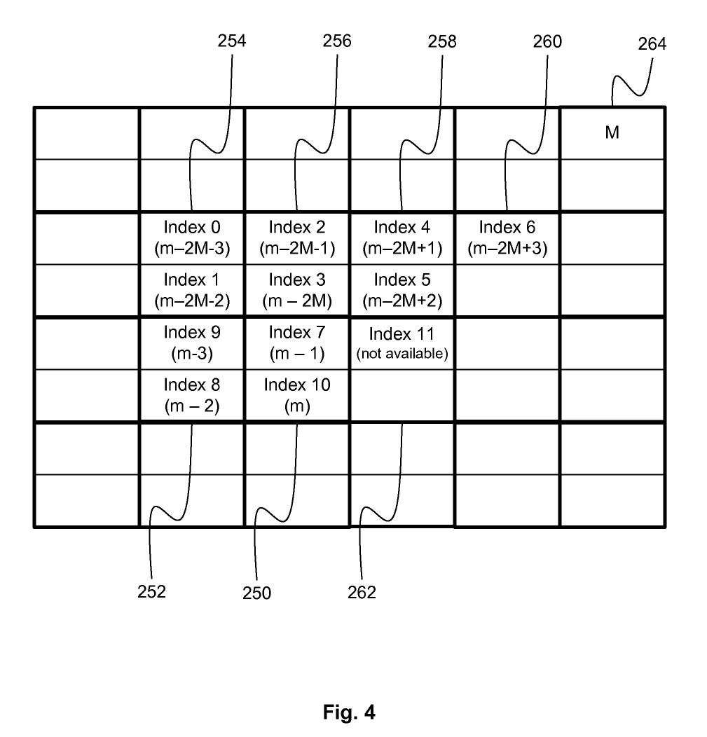

FIG. 4 is an illustration of an indexing scheme for a picture of a MBAFF coded video stream with rows that stretch M macroblocks pairs. Referring to FIG. 4 and following the indexing scheme for MBAFF coded video streams, MB pair 250 can be assigned Index 10 for the bottom MB and Index 7 for the top MB, MB pair 252 can be assigned Index 9 for the top MB and Index 8 for the bottom MB, MB pair 254 can be assigned Index 0 for the top MB and Index 1 for the bottom MB, MB pair 256 can be assigned Index 2 for the top MB and Index 3 for the bottom MB, MB pair 258 can be assigned Index 4 for the top MB and Index 5 for the bottom MB, MB pair 260 can be assigned Index 6 for the top MB, and other MBs, such as the top MB in MB pair 262, can be assigned Index 11.

For MBAFF coded video streams, the neighboring location is not only related to the current location, but is also related to three other factors: (1) currMbFrameFlag which indicates whether the current MB Pair is encoded as frame MBs or field MBs; (2) mbIsTopMbFlag which indicates whether the current MB is the top or bottom MB of the MB Pair; and (3) macroblock mbX whose MB address can be defined in the H.264 standard.

As discussed earlier, there is a total of twenty-six different types of partitions used for calculating neighboring locations, each of these partitions may have four neighboring locations, such as the left block, the top block, the top-right block, and the top-left block. The four neighbors may take up to 2-bits of memory space. Each neighboring location can be defined differently based on the following parameters, currMbFrameFlag and mbIsTopMbFlag, where each parameter may need up to 1-bit of memory space. Therefore each partition can have sixteen different neighboring locations. If each partition has a one-to-one corresponding entry, then there will be 26*16=416 entries in the uncompressed table of neighboring locations, shown in Appendix D and may be also referred to as “uncompressed neighboring locations table.”

An entry for each neighboring location may have six fields. The six fields may include the following: (1) a field for validity to indicate whether this is a valid entry (1 valid/0 invalid); (2) a field for X_Mbno to indicate the index of macroblock mbX; (3) a field for fld_Mbno to indicate the index of the MB for the neighboring location if mbX is a field MB; (4) a field for fld_blkno to indicate the block number for the neighboring location if mbX is a field MB; (5) a field for frm_Mbno to indicate the index of MB for the neighboring location if mbX is a frame MB; and (6) a field for frm_blkno to indicate the block number for the neighboring location if mbX is a frame MB.

Based on the observation that many of the entries take identical values, the uncompressed neighboring locations table can be reduced by only keeping one entry for multiple identical entries. It turns out that there are only fifty-eight distinctive entries. One more entry can be added for indicating the availability of a MB (entry 0). Thus, a total of fifty-nine entries are in this compressed neighboring locations table, illustrated in Appendix E. Each entry contains the fields X_Mbno, fld_Mbno, fld_blkno, frm_Mbno, and frm_blkno. The neighboring location may be written in the following format: {X_Mbno, fld_Mbno, fld_blkno, frm_Mbno, frm_blkno}.

Since the index of the compressed neighboring locations table no longer has a one-to-one correspondence to the different types of partitions, index tables are needed to access the compressed neighboring locations table (shown in Appendix E) for MBAFF coded video streams. Each index table may correspond to different combinations of the MBAFF parameters, currMbFrameFlag and mbIsTopMbFlag, as illustrated in Appendix F.

Within each table, there are twenty-six entries corresponding to the twenty-six different kinds of relevant partitions. And within each entry, there can be four fields corresponding to the four neighboring locations, where the value of the first field, idx_A, can be used to index the compressed neighboring locations table for the left neighboring location, the value of the second field, idx_B, can be used to index the compressed neighboring locations table for the top neighboring location, the value of the third field, idx_C, can be used to index the compressed neighboring locations table for the top-right neighboring location, and the value of the fourth field, idx_D, can be used to index the compressed neighboring locations table for the top-left neighboring location. The four index tables are shown in Appendix F.

In the four index tables, some entries have the same values. Thus, the four index tables can be reduced, similarly to the uncompressed neighboring locations table, by extracting and storing every distinctive entry only once. It turns out that the compressed index table only needs sixty-eight entries, instead of the cumulative one hundred and four entries for the four index tables, 4*26=104 entries. The compressed index table is shown in Appendix G.

Since the compressed index table is compressed, four secondary index tables are needed to access the compressed index table. These four secondary index tables correspond to different combinations of currMbFrameFlag (1-bit) and mbIsTopMbFlag (1-bit), where the secondary index tables can by identified by the following format Snd_Index_Tab (currMbFrameFlag)(mbIsTopMbFlag). Every entry in the secondary index tables may contain only one field, which can be an index to one entry in the compressed index table. The four secondary index tables are shown in Appendix H.

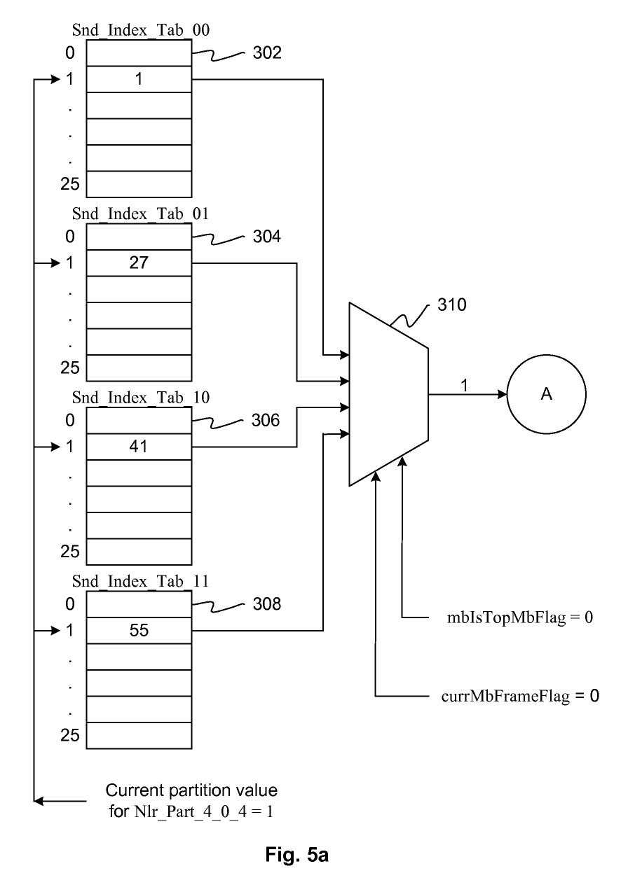

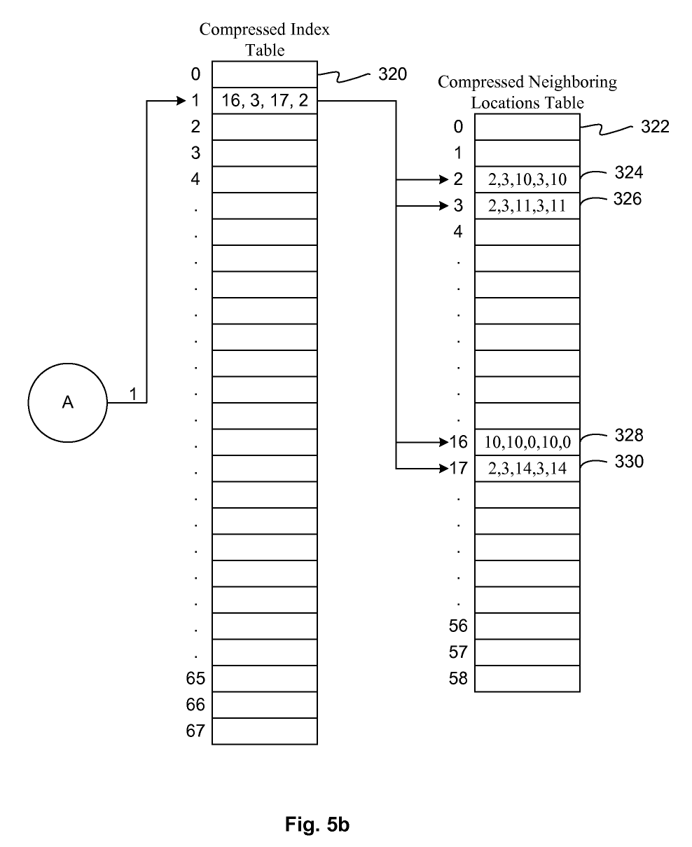

FIGS. 5a-5b illustrate the process for determining the neighboring locations using the secondary index tables, compressed index table, and compressed neighboring locations table for MBAFF coded video streams. Referring to FIGS. 5a -5b, given a current partition, Nlr_Part_4_0_4, and assuming the currMbFrameFlag=0 and mbIsTopMbFlag=0, the neighboring locations can be determined through the following three steps.

In the first step, the currMbFrameFlag and mbIsTopMbFlag can be used to identify the associated secondary index table. Here, since both values for currMbFrameFlag and mbIsTopMbFlag are zero, the corresponding secondary index table is Snd_Index_Tab_00, table 302. Using the current partition value to index table 302, the value of the corresponding entry is 1.

In the second step, the value 1 from step one can be used to index the compressed index table, table 320. Using index value 1 to lookup the corresponding entry, the corresponding entry for the compressed index table returns the values 16, 3, 17, and 2. The four values within each entry of the compressed index table can then be used to index the four neighboring locations on the compressed table of neighboring locations, where the first value is used to index the left MB, the second value is used to index the top MB, the third value is used to index the top-right MB, and the fourth value is used to index the top-left MB.

In the third step, the four values found in step two can be used to index the compressed neighboring locations table 322, where the corresponding entries give the neighboring locations. Here, index value 16 returns the entry 328 with the neighboring location for the left MB of {10, 10, 0, 10, 0 }, index value 3 returns the entry 326 with the neighboring location for the top MB of {2, 3, 11, 3, 11 }, index value 17 returns the entry 330 with the neighboring location for the top-right MB of {2, 3, 14, 3, 14 }, and index value 2 returns the entry 324 with the neighboring location for the top-left MB of {2, 3, 10, 3, 10 }, where the neighboring location entries are written in the form: {X_Mbno, fld_Mbno, fld_blkno, frm_Mbno, frm_blkno}.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. A method for determining one or more neighboring locations for a current partition of a picture in the decoding of a video stream, comprising the steps of:
determining the possible partitions for each macroblock of a picture, wherein the picture is divided into one or more macroblocks;
reducing the number of possible partitions to a plurality of relevant partitions, wherein the relevant partitions are used to generate one or more relevant tables;
calculating the neighboring locations for each of the relevant partitions;
generating a neighboring locations table as a function of the corresponding relevant partitions; and
determining the neighboring locations for the current partition using the neighboring locations table.

2. The method of claim 1 wherein the video stream conforms to the H.264 standard.

3. The method of claim 1 wherein in the calculating step, the neighboring locations are calculated based on an indexing scheme for non-MBAFF coded video streams.

4. The method of claim 1 wherein in the calculating step, the neighboring locations are calculated based on an indexing scheme for MBAFF coded video streams.

5. The method of claim 4 wherein in the calculating step, the neighboring locations are calculated as function of a currMbFrameFlag and a mbIsTopMbFlag.

6. The method of claim 5 wherein after the generating step, the neighboring locations table is reduced by eliminating duplicated entries in said table that have identical values.

7. The method of claim 4 wherein in the first determining step, the possible partitions are calculated as function of a currMbFrameFlag and a mbIsTopMbFlag.

8. The method of claim 7 further comprising the step after the generating step of, generating secondary index tables as a function of relevant partitions and the neighboring locations table.

9. The method of claim 1 wherein after the generating step, the neighboring locations table is reduced by eliminating duplicated entries in said table that have identical values.

10. The method of claim 2 wherein in the calculating step, the neighboring locations are calculated as function of a currMbFrameFlag and a mbIsTopMbFlag.

11. The method of claim 3 wherein after the generating step, the neighboring locations table is reduced by eliminating duplicated entries in said table that have identical values.

12. The method of claim 4 wherein after the generating step, the neighboring locations table is reduced by eliminating duplicated entries in said table that have identical values.

13. The method of claim 7 further comprising the step after the generating step of, generating secondary index tables as a function of relevant partitions and the neighboring locations table.

14. A method for determining one or more neighboring locations for a current partition of a picture in the decoding of a video stream, comprising the steps of:
determining the possible partitions for each macroblock of a picture, wherein the picture is divided into one or more macroblocks;
reducing the number of possible partitions to a plurality of relevant partitions, wherein the relevant partitions are used to generate one or more relevant tables;
calculating the neighboring locations for each of the relevant partitions, wherein the neighboring locations are calculated based on an indexing scheme for MBAFF coded video streams;
generating a neighboring locations table as a function of the corresponding relevant partitions, wherein the neighboring locations table is reduced by eliminating duplicated entries in said table that have identical values; and
determining the neighboring locations for the current partition using the neighboring locations table.

15. The method of claim 14 wherein the video stream conforms to the H.264 standard.

16. The method of claim 14 wherein in the calculating step, the neighboring locations are calculated as function of a currMbFrameFlag, and a mbIsTopMbFlag.

17. The method of claim 14 wherein in the first determining step, the possible partitions are calculated as function of a currMbFrameFlag and a mbIsTopMbFlag.

18. The method of claim 17 further comprising the step after the generating step of, generating secondary index tables as a function of relevant partitions and the neighboring locations table.

19. The method of claim 16 further comprising the step after the generating step of, generating secondary index tables as a function of relevant partitions and the neighboring locations table.

20. A method for determining one or more neighboring locations for a current partition of a picture in the decoding of a video stream, wherein the video stream conforms to the H.264 standard, comprising the steps of:
determining the possible partitions for each macroblock of a picture, wherein the picture is divided into one or more macroblocks;
reducing the number of possible partitions to a plurality of relevant partitions, wherein the relevant partitions are used to generate one or more relevant tables;
calculating the neighboring locations for each of the relevant partitions, wherein the neighboring locations are calculated based on an indexing scheme for MBAFF coded video streams;
generating a neighboring locations table as a function of the corresponding relevant partitions, wherein the neighboring locations table is reduced by eliminating duplicated entries in said table that have identical values;
generating secondary index tables as a function of relevant partitions and the neighboring locations table; and
determining the neighboring locations for the current partition using the neighboring locations table.
